(19) United States
(12) Patent Application Publication
(10) Pub. No.: US 2022/0084024 A1
(43) Pub. Date: Mar. 17, 2022

(54) SYSTEMS AND METHODS FOR FACILITATING LOCATION-BASED INTERACTIONS BY REDUCING INTERCHANGE FEES

(71) Applicant: Capital One Services, LLC, McLean, VA (US)

(72) Inventors: Michael MOSSOBA, Arlington, VA (US); Abdelkader BENKREIRA, New York, NY (US); Joshua EDWARDS, Philadelphia, PA (US)

(73) Assignee: Capital One Services, LLC, McLean, VA (US)

(21) Appl. No.: 17/022,830

(22) Filed: Sep. 16, 2020

(51) Int. Cl. G06Q 20/40; G06Q 20/38

(52) U.S. Cl. CPC G06Q 20/401; G06Q 20/389; G06Q 20/385

(57) ABSTRACT

A computer-implemented method for providing a location-based interaction-type strategy may include: receiving an indication, from a mobile device associated with a user, that the mobile device has detected that the user is at a location associated with an entity; and in response to receiving the indication that the user is at the location associated with the entity: obtaining interaction data for a plurality of interaction types associated with the user; based on the interaction data, determining a respective interchange assessment of an interaction with the entity with each of the plurality of interaction types; and transmitting a strategy of at least one of the plurality of interaction types to the mobile device based on the respective interchange assessment.

### TECHNICAL FIELD

Various embodiments of the present disclosure relate generally to processed transactions, and, more particularly, to systems and methods for reducing interchange assessments of location-based interaction by recommending an interaction type, e.g., a payment method to a user and/or providing an incentive for the interaction type to the user.

### BACKGROUND

An interaction including a processed transaction, e.g., a transaction conducted via an instrument other than cash and that may be processed by one or more third parties in order to be executed, may include processing operations such as authorization, clearing, settlement, and funding. Third parties, e.g., parties other than a buyer or seller or the like, may include entities such as a payment processor, a payment instrument issuer (e.g., a credit card company), a banking institution, etc.

Although the operations may vary from transaction to transaction, generally, a processed transaction may proceed as follows. A user, e.g., a customer may initiate an interaction including a processed transaction by presenting an interaction item, e.g., a non-cash instrument such as a credit or debit card, token, scrip, coupon, note, check, e-payment, etc., to a merchant. To authorize the instrument, the merchant may submit interaction data, e.g., merchant transaction data, associated with the interaction to a payment processor. The payment processor may verify that the customer has sufficient funds to execute the transaction, e.g., by transmitting at least a portion of the interaction data to the instrument issuer, which may return an authorization to the payment processor and/or the merchant, as appropriate. The merchant may then proceed with the interaction. Thereafter, the merchant may from time to time submit a settlement request to the payment processor, which may initiate a transfer of funds from the instrument issuer to the merchant, e.g., via one or more banking institutions. The instrument issuer may also request a settlement from the user from time to time, e.g., via a credit card bill, clearing a check from the user's banking institution, etc.

Any or all of operations that may be included in a processed transaction, such as the operations discussed above, may include interchange assessments charged against the merchant. Each entity involved with an interaction including a processed transaction may apply an interchange assessment with an amount based on one or more aspects of the transaction. Such aspects may include, for example, a price applied to the interaction, the type of interaction item used (e.g., credit card, check, e-payment, etc.), a rate or rate category for the instrument used (e.g., a personal credit card, a business account, a rewards card, etc.), a rate or rate category for a Point-of-Sale device used to process the payment, a location of the merchant, the user, or the interaction, the type and/or quantity of information about the user and/or interaction item captured or verified during the interaction, or other factors. In other words, interactions including transactions for the same product by the same user from the same merchant may incur different interchange assessments depending on the characteristics of each interaction, and in particular on the interaction item used to execute the transaction.

Moreover, a user may be in possession of several different interaction items or types of interaction items. For example, a user may be in possession of one or more credit cards from different issuers and/or in different rate categories, a check, an electronic application such as an electronic wallet, etc., or may be able to choose between visiting the merchant at a physical store vs. an e-commerce website, or the like. A user may also choose from a variety of modalities for a payment instrument, e.g., use a physical interaction item, e.g., a payment card via a POS device, use a card number (e.g., that is called in or transmitted to a payment processor), use an electronic version of the interaction item, e.g., that is stored in an e-wallet, use the interaction item via an electronic transaction, etc. A merchant may prefer that a user select an available interaction item that would minimize the interchange assessment charged to the merchant. However, the merchant may be unaware of the interaction options available to the user, making it difficult to make any recommendations. Further, the user may not be aware of how selection of an interaction item may affect the merchant, and/or the interchange assessments associated with their various payment instruments. Additionally, even if such information were available, it may be difficult for the merchant to incentivize the user to select a particular interaction option.

The present disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for facilitating processed transactions by reducing interchange assessments.

In one aspect, an exemplary embodiment of a computer-implemented method for providing a location-based interaction-type strategy may include: receiving an indication, from a mobile device associated with a user, that the mobile device has detected that the user is at a location associated with an entity; and in response to receiving the indication that the user is at the location associated with the entity: obtaining interaction data for a plurality of interaction types associated with the user; based on the interaction data, determining a respective interchange assessment of an interaction with the entity with each of the plurality of interaction types; and transmitting a strategy of at least one of the plurality of interaction types to the mobile device based on the respective interchange assessment.

In another aspect, an exemplary embodiment of a location-based interaction type strategy system may include: a memory storing instructions; a multi-slot item reader configured to read data from a plurality of interaction items; an input device; a display; and at least one processor operatively connected to the memory, the multi-slot item reader, the input device, and the display, and configured to execute the instructions to perform acts. Such acts may include: receiving interaction data, from the multi-slot item reader, for the plurality of interaction items; and in response to receiving the interaction data: based on the interaction data, determining a respective interchange assessment of a interaction with an entity with each of the plurality of interaction items; and outputting, on the display, a strategy of at least one of the plurality of interaction items based on the respective interchange assessment.

In a further aspect, an exemplary embodiment of a location-based interaction type strategy system may include: a memory storing instructions; and at least one processor operatively connected to the memory, and configured to execute the instructions to perform acts. Such acts may include: receiving an indication, from a mobile device associated with a user, that the mobile device has detected that the user is at a location associated with an entity, wherein the detection by the mobile device that the user is at the location associated with the entity is based on one or more of: location data of the mobile device matching the location associated with the entity; or network connection data the mobile device including one or more of a detection to or a connection with a local electronic network associated with the entity; and in response to receiving the indication that the user is at the location associated with the entity: obtaining interaction type data for a plurality of interaction types associated with the user; determining a respective Bank Identification Number (“BIN”) for each of the plurality of interaction types based on the interaction type data; based on the respective BIN and the interaction type data, determining a respective interchange assessment of a interaction with the entity with each of the plurality of interaction types; and transmitting a strategy of at least one of the plurality of interaction types to the mobile device based on the respective interchange assessment, wherein the strategy includes an interaction type corresponding to a lowest of the respective interchange assessment.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary computing environment for providing a location-based interaction-type strategy by reducing interchange assessments, according to one or more embodiments.

FIG. 2 depicts a flowchart of an exemplary method for providing a location-based interaction-type strategy by reducing interchange assessments, according to one or more embodiments.

FIG. 3 depicts a flowchart of another exemplary method for providing a location-based interaction-type strategy by reducing interchange assessments, according to one or more embodiments.

FIG. 4 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

The term “merchant” generally encompasses an entity or person involved in providing, selling, and/or renting products to customers such as a seller, dealer, renter, provider, vendor, or the like, as well as an agent or intermediary of such an entity or person. The terms “user,” “customer,” and the like may be used interchangeably, and generally encompass a person interested in or engaged in a purchase or rental of a product, or a person that has purchased a product. A “product” generally encompasses a good, service, or the like having ownership or other rights that may be transferred. A location associated with a merchant generally encompasses a location, physical and/or electronic, at which a customer may purchase a product from the merchant such as a store, e-commerce website, kiosk, etc. The term “interaction” generally encompasses any communication that concerns a potential, in progress, or executed transfer of a product. The term “interaction item” generally encompasses an item, medium, note, token, identification, authorization, or the like that may be presented, negotiated, transmitted, verified, recorded, or the like in order to authorize, execute, or facilitate an interaction.

A customer may desire to use an interaction items such as a non-cash payment instrument to complete an interaction that includes a transaction, and an entity such as a merchant may desire to minimize interchange assessments incurred when executing the customer's transaction. However, the merchant may be unaware of the interaction options available to the customer, the customer may be unaware of and/or unconcerned by the effect of different interaction items on the assessments incurred by the merchant. Accordingly, improvements in technology relating to facilitating interactions including processed transactions to reduce interchange assessments are needed.

In the following description, embodiments will be described with reference to the accompanying drawings. As will be discussed in more detail below, in various embodiments, systems and methods for facilitating interactions e.g., by providing a location-based interaction-type strategy and/or providing an incentive for the interaction item to the user, are described.

In an exemplary use case, a customer may desire to make a purchase at a physical store of a merchant. When making the purchase, the customer may provide a plurality of different interaction items, e.g., different payment cards, to a Point-Of-Sale (“POS”) system that includes a multi-slot item reader, e.g., configured to simultaneously receive multiple payment cards and read data from the multiple payment cards. The POS system and/or a merchant system (e.g., entity system) or location-based interaction-type strategy system operating in conjunction with the POS system may use the read data to determine respective interchange assessments that would be incurred for the transaction using each of the multiple payment cards. For example, the merchant system, location-based interaction-type strategy system, and/or a third-party system such as a payment processor system or banking institution system may include interchange assessment data usable to determine an interchange assessment based on data associated with a payment instrument. Based on the determined interchange assessments, one or more of the multiple payment cards may be recommended to the customer and/or merchant for selection in the transaction. The recommendation may be based on, for example, one or more of a comparison of the values of the interchange assessments, incentives available to the customer for the different payment cards, or the like. In some instances, such as in response to previous instructions received from the customer and/or merchant, one of the payment cards may be automatically selected. In some instances, the customer may select a payment card, e.g., via an interface of the POS system, by removing un-selected payment cards, and/or by re-submitting the selected payment card. The transaction may then be processed with the selected payment card.

In another exemplary use case, a customer may travel to a location associated with a merchant, e.g., a physical store operated by the merchant. A mobile device associated with the customer may determine that the customer has traveled to the location associated with the merchant, e.g., by detecting that a location of the mobile device matches the location associated with the merchant. In response to such determination, the mobile device and/or a location-based interaction-type strategy system operating in conjunction with the customer device may obtain interaction data for a plurality of different interaction types associated with the customer, e.g., payment method data for a plurality of payment methods associated with the customer. Such data may be obtained, for example, from a profile associated with the customer, an electronic wallet of the customer, a location-based interaction-type strategy system, or the like. Based on the payment method data, the location-based interaction-type strategy system may determine a respective interchange assessment of an interaction, e.g., a transaction, with the merchant with each of the plurality of payment methods. The location-based interaction-type strategy system may transmit a recommendation of at least one of the plurality of payment methods to the customer device based on the respective interchange assessments. In some instances, the transmission may be configured to cause the mobile device, e.g., an electronic application installed thereon, to generate a selectable representation of the at least one of the plurality of payment methods that, in response to selection of a payment method, activates the selected payment method for use so that it is ready for a transaction between the merchant and the customer. The customer thus has a seamless experience whereby a payment method recommendation and/or selection is already provided at the time when they are attempting to process a payment. In other words, from the customer's perspective, the customer may arrive at the store, and collect a desired product. When the customer presents the product to the merchant for purchase, the customer may access the mobile device, which may have a payment method already recommended and/or selected so that the customer may efficiently present the payment method to the merchant and execute the transaction.

In a further exemplary use case, a customer may desire to make a purchase at a physical store of a merchant. When making the purchase, the customer may provide an interaction item, e.g., a payment card, to a POS system configured to read data from the received payment instrument. The POS system may submit a recommendation request to a location-based interaction-type strategy system. In response to such request, the location-based interaction-type strategy system may obtain payment method data for a plurality of payment methods associated with the customer, e.g., from a profile associated with the customer, an electronic wallet of the customer, or the like. Based on the payment method data, the location-based interaction-type strategy system may determine a respective interchange assessment of a transaction with the merchant with each of the plurality of payment methods. The location-based interaction-type strategy system may transmit a recommendation of at least one of the plurality of payment methods to the customer device and/or the POS system based on the respective interchange assessments. In some instances, the transmission may be configured to cause the POS system and/or the customer device, e.g., an electronic application installed thereon, to generate a selectable representation of the at least one of the plurality of payment methods that, in response to select of a payment method, authorizes the selected payment method for use in the transaction. The customer thus has a seamless experience whereby the customer's full electronic wallet of different payment instruments is available even when the customer only has a single physical payment instrument.

In another exemplary use case similar to the previous example, instead of and/or in addition to accessing payment method data from the location-based interaction-type strategy system, customer profile, etc., the payment instrument provided by the customer may include data associated with a plurality of payment instruments that may be provided to the location-based interaction-type strategy system, e.g., via the POS system.

In an additional exemplary use case, the customer may desire to make a purchase at an e-commerce store of a merchant such as an online website or the like, e.g., via a customer device. When making the purchase, an electronic application, e.g., a plugin, program, or the like, installed on the customer device may submit a recommendation request to a location-based interaction-type strategy system. In response to such request, the location-based interaction-type strategy system may obtain payment method data for a plurality of payment methods associated with the customer, e.g., from a profile associated with the customer, an electronic wallet of the customer, or the like. Based on the payment method data, the location-based interaction-type strategy system may determine a respective interchange assessment of a transaction with the merchant with each of the plurality of payment methods. The location-based interaction-type strategy system may transmit a recommendation of at least one of the plurality of payment methods to the customer device based on the respective interchange assessments. In some instances, the transmission may be configured to cause the customer device, e.g., the electronic application installed thereon, to generate a selectable representation of the at least one of the plurality of payment methods that, in response to select of a payment method, authorizes the selected payment method for use in the transaction. The customer thus has a seamless experience whereby the customer's full electronic wallet of different payment instruments is available.

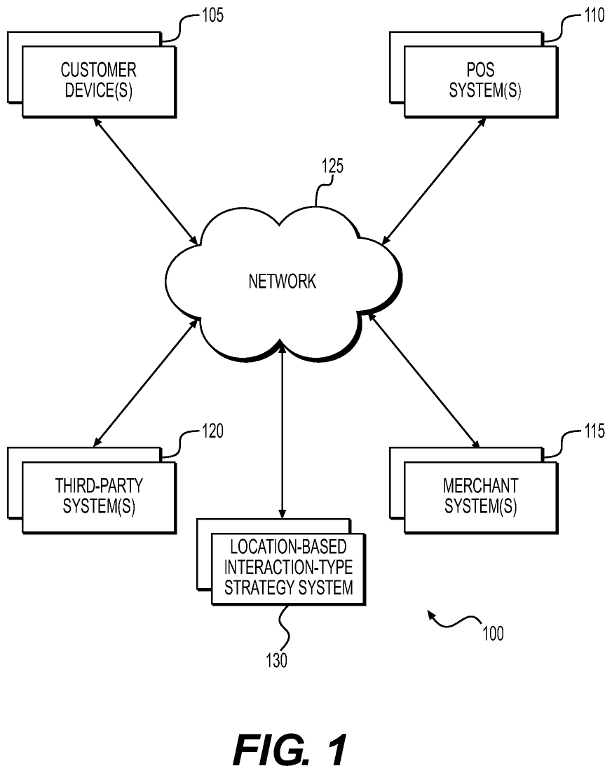

FIG. 1 depicts an exemplary computing environment 100 that may be utilized with techniques presented herein. One or more customer device(s) 105, one or more POS system(s) 110, one or more merchant system(s) 115, and/or one or more third-party system(s) 120 may communicate across an electronic network 125. As will be discussed in further detail below, one or more location-based interaction-type strategy system(s) 130 may communicate with one or more of the other components of the computing environment 100. The systems and devices of the computing environment 100 may communicate in any arrangement. As will be discussed herein, systems and/or devices of the computing environment 100 may communicate in order to facilitate a processed transaction in order to reduce interchange assessments, e.g., by recommending one or more payment methods to a customer and/or providing an incentive for the one or more payment methods to the customer.

The customer device 105, e.g., a user device, may be a computer system such as, for example, a desktop computer, a mobile device, etc. In an exemplary embodiment, the customer device 105 is a mobile device such as a cellphone, or the like. In some embodiments, the customer device 105 may include one or more electronic application(s), e.g., a program, plugin, etc., installed on a memory of the customer device 105. In some embodiments, the electronic application(s) may be associated with one or more of the other components in the computing environment 100. For example, the electronic application(s) may include customer authentication tools, a digital wallet of the customer, an application that provides access to an e-commerce store-front of a merchant associated with the merchant device, product search tools, or the like.

In some embodiments, the customer device 105 includes one or more sensors configured to capture data such as, for example a camera configured to capture image data, a microphone configured to capture audio data, a positioning device configured to capture location data, a wireless communications antenna, or any other suitable type of sensor or receiver.

In some embodiments, the POS system 110 may include one or more input devices such as, for example, one or more of a magnetic card reader, an RFID or near-field chip reader, an infrared sensor, a keyboard or keypad, a touch-screen input device, a wired and/or wireless communications antenna, or the like. In some embodiments, the POS system 110 includes a multi-item reader (e.g., a card reader with multiple slots, a chip reader with multiple readers, etc.) configured to simultaneously receive and/or read interaction data, e.g., payment method data, from multiple interaction items, e.g., payment cards. In some embodiments, the POS system 110 may be configured to capture, e.g., via the one or more input devices, entity interaction data, e.g., merchant transaction data associated with a processed transaction. Transaction data may include, for example, one or more of a transaction price, product(s) associated with the transaction, etc. Transaction data may also include information associated with an interaction item provided by a customer and/or the customer device 105 such as, for example, one or more of interaction item type, an issuer associated with the interaction item, an account number for the interaction item, authentication information for the interaction item, expiration date information for the interaction item, etc. Interaction data, e.g., customer transaction data, may also include information associated with the customer such as, for example, one or more of a name, address, contact information, other payment instruments available to the customer, etc.

The merchant system 115, the location-based interaction-type strategy system 130, and/or the third-party system 120 may include interchange assessment information associated with the merchant. Generally, a merchant may have one or more agreements, contracts, and/or negotiated rates for interchange assessments with one or more entities such as a third party (e.g., an entity such as a payment processor, banking institution, or the like, associated with the third-party system 120), and the interchange assessment information may include data usable to determine an interchange assessment for a particular transaction with the merchant via a particular payment instrument.

The merchant system 115, the location-based interaction-type strategy system 130, and/or the third-party system 120 may include incentive data and/or information associated with the customer. A customer may have one or more incentives with a payment processor, banking institution, the merchant, or the like such as a rewards program, membership points, cash back allowance for a transaction, etc. The merchant system 115 may also have and/or provide one or more incentives associated with payment methods and/or interchange assessments, as discussed in more detail below.

In various embodiments, the electronic network 125 may be a wide area network (“WAN”), a local area network (“LAN”), personal area network (“PAN”), or the like. In some embodiments, electronic network 125 includes the Internet, and information and data provided between various systems occurs online. “Online” may mean connecting to or accessing source data or information from a location remote from other devices or networks coupled to the internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). In some embodiments, the electronic network 125 includes or is in communication with a telecommunications network, e.g., a cellular network.

As discussed in further detail below, the location-based interaction-type strategy system 130 is configured to one or more of recommend, activate, provide, or process one or more interaction items or types, e.g., one or more payment methods or payment instruments, for an interaction including a transaction between the customer and the merchant. Although depicted as separate components in FIG. 1, it should be understood that a component or portion of a component may, in some embodiments, be integrated with or incorporated into one or more other components. For example, a portion of the merchant system 115 may be provided to the customer device 105 as an electronic portal via the electronic application. At least a portion of location-based interaction-type strategy system 130 may be integrated into the POS system 110, the merchant system 115, the customer device 105, and/or the third-party system 120. Any suitable arrangement of the various systems and devices of the computing environment may be used.

In the methods below, various acts are described as performed or executed by a component from FIG. 1 such as the location-based interaction-type strategy system 130. However, it should be understood that in various embodiments, various components of the computing environment discussed above may execute instructions or perform acts including the acts discussed below. Further, it should be understood that in various embodiments, various steps may be added, omitted, and/or rearranged in any suitable manner.

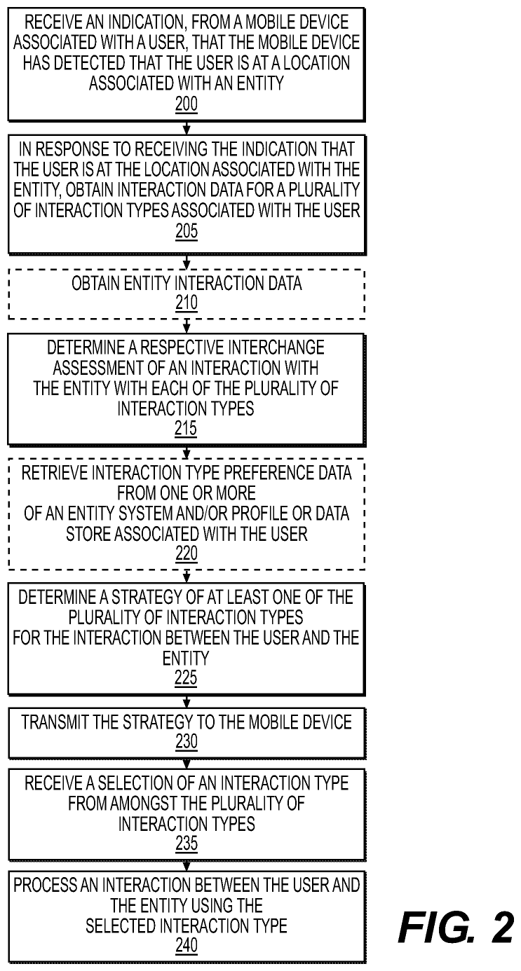

FIG. 2 illustrates an exemplary process for recommending a payment method for a transaction between a customer and a merchant, such as in the various examples discussed above. A customer may desire to make a purchase from a merchant at a physical store associated with the merchant. The customer may have and/or be associated with a customer device 105, e.g., a mobile device. The mobile device may determine that the customer is moving toward, is close to, is arriving at, or is located at a location associated with the merchant, e.g., based on a comparison of a location of the mobile device and the location associated with the merchant. In some embodiments, the determination may be based on an indication received via the customer, e.g., via the customer's input or selection of a location or merchant in an electronic application associated with the location-based interaction-type strategy system 130. In some embodiments, the mobile device may be equipped with at least one sensor, and the determination may be based on the at least one sensor. The at least one sensor may include, for example, one or more of a Global Positioning System (“GPS”), a camera, a wireless antenna, a microphone, etc. The location associated with the merchant may include, for example, a geographic region, an address, a geo-fenced area, and/or an area in range of a signal produced by a device associated with the merchant such as a wireless signal, audio signal, visual signal, or the like.

The wireless signal may include a wireless transmission, and/or may be network connection data associated with a wireless network provided by and/or associated with the merchant. In some embodiments, the wireless transmission may include information associated with the merchant such as interchange assessment information, incentive data and/or information, or the like. For example, the mobile device may determine that the customer has arrived at the location based on the mobile device connecting to a wireless network associated with the merchant.

The audio signal may be a sound or tone associated with the merchant, and may or may not be audible to a human listener. For example, the merchant may have a device that produces a tone or sound at an entry or within the premises of the store that may be detected by the mobile device. The visual signal may be any visual element that may be captured via a cameral or the like that may be associated with the merchant and or the location associated with the merchant such as a QR code, an image of the physical store, etc. In some embodiments, the mobile device is configured to determine that the customer has been at the location associated with the merchant for at least a predetermined period of time, e.g., in order to reduce false positives when a customer is in transit or is only browsing. In some embodiments, the predetermined period of time may be predetermined by the customer, the merchant, the location-based interaction-type strategy system 130, and/or other entities.

In response to such determination, the mobile device (e.g., customer device 105) may transmit an indication to the location-based interaction-type strategy system 130 that the mobile device has detected that the customer is at the location associated with a merchant.

At step 200, the location-based interaction-type strategy system may receive the indication that the mobile device has detected that the customer is at the location associated with the merchant.

At step 205, in response to receiving the indication that the mobile device has detected that the customer is at a location associated with a merchant, the location-based interaction-type strategy system 130 may obtain interaction data for a plurality of interaction types associated with the customer, e.g., payment method data for a plurality of payment methods associated with the customer. In some embodiments, one or more of the electronic application installed on the customer device 105, the location-based interaction-type strategy system 130, or the third-party system 120 may include information associated with the customer. For example, such sources may include a profile, electronic wallet, data store, or the like associated with the customer that includes at least a portion of the payment method data, and the location-based interaction-type strategy system 130 may obtain data such as the payment method data from one or more of such sources or other sources. Payment method data for a payment method may include, for example, a payment account number, an expiration date, information associated with a payment instrument issuer, information associated with a banking institution associated with the payment method and/or the customer, authentication information, customer information such as name or address, payment instrument category information (e.g., a rewards card, student card, business card, etc.), one or more incentives associated with the payment method (e.g., cash back, membership points, etc.), available funds or credit, or the like.

Optionally, at step 210, the location-based interaction-type strategy system 130 may retrieve, e.g., from the merchant system 115, the POS system 110, or another system, entity interaction data such as merchant data. Merchant data may include, for example, the location associated with the merchant, information associated with the POS system 110, or the like.

At step 215, the location-based interaction-type strategy system 130 may determine a respective interchange assessment of a transaction with the merchant with each of the plurality of payment methods. Determining a respective interchange assessment may include, for example, comparing the payment method data for a particular payment method to interchange assessment information that may be stored by one or more of the merchant system 115, the location-based interaction-type strategy system 130, the third-party system 120, or another system, and the location-based interaction-type strategy system 130 may access one or more of such sources and/or other sources to obtain the interchange assessment data. Factors that may affect an amount for an interchange assessment, and thus information that may be obtained by the location-based interaction-type strategy system 130, may include, for example, the type of instrument used (e.g., credit card, check, e-payment, etc.), a rate or rate category for the instrument used (e.g., a personal credit card, a business account, a rewards card, etc.), a rate or rate category for POS system 110, the location associated with the merchant, the customer's address, the type and/or quantity of information about the customer and/or payment instrument captured or verified during the transaction, or other factors.

In some embodiments, interchange assessments may depend on the price and/or product(s) included in a transaction. To determine a respective interchange assessment without knowledge of the product(s) or transaction price (e.g., before the customer has selected a product and/or presented the product to the merchant for purchase), the location-based interaction-type strategy system 130 may, for example, utilize a default purchase price or product selection and/or a predicted purchase price or product selection. A default may be predetermined by one or more of the merchant, the location-based interaction-type strategy system 130, the third-party system 120, the customer, or another entity. In some embodiments, a predicted purchase price or product selection may be determined based on, for example, historical transactions of the customer with the merchant and/or other merchants, and/or historical transactions of one or more other customers with the merchant and/or other merchants. In some embodiments, the customer may provide a predicted product and/or transaction price.

In some embodiments, the payment method data of at least one payment method in the plurality of payment methods includes a Bank Identification Number (“BIN”) that is indicative of an identity of the payment method, and/or that may be usable to identify interchange assessments that may be applied to a transaction in which that payment method is used. In some embodiments, determining a respective interchange assessment of a transaction with a payment method includes determining a respective Bank Identification Number (“BIN”) for the payment method based on the payment method data, using the BIN to retrieve interchange assessment information associated with the payment method (e.g., via the interchange assessment data), and then determining an interchange assessment for the payment method based on the retrieved interchange assessment information.

Optionally, at step 220, the location-based interaction-type strategy system 130 may retrieve interaction type preference data, e.g., payment method preference data from one or more of the merchant system 115 and/or the profile or data store associated with the customer. Payment method preference data from the merchant system 115 may include information indicative of a relative preference for one or more payment methods, e.g., a ranking, scoring, or the like. In some embodiments, such ranking may be based on the interchange assessment(s) associated with the payment methods, or other factors. In some embodiments, the payment method preference data may include incentive data associated with one or more incentives for the customer to select one or more of the payment methods. An incentive may include, for example, cash back, membership points, discounts, bonus products, coupons, or any other suitable reward or benefit.

For example, in some embodiments, a merchant may predetermine an incentive for a particular payment method that has a low interchange assessment relative to other payment methods. The incentive may motivate the customer to select that payment method, so that the customer receives the incentive and the merchant saves, for example, the difference in the value of the interchange assessments. In some instances, an incentive has a value based on the values of the determined interchange assessments for the plurality of payment methods. For example, in some instances, the incentive may be based on a comparison between the values of the interchange assessments and a predetermined value, e.g., an average interchange assessment or rate incurred by the merchant. In some instances, the incentive may be based on a comparison of the values of the interchange assessments, e.g., based on a difference between a relatively higher interchange assessment and a relatively lower interchange assessment.

In an illustrative example, the merchant system 115 and/or the location-based interaction-type strategy system 130 may determine that a first payment method available to the customer may result in an interchange assessment of $1.00, while a second payment method available to the customer may result in an interchange assessment of $2.00. The merchant system 115 may be configured to determine a potential savings between the two interchange assessments, e.g., a difference of $1.00, and may determine a value for an incentive based on the potential savings, e.g., a 50/50 split or any other suitable division. A 50/50 split would result in both the customer and the merchant saving $0.50 if the first payment method is used instead of the second payment method.

In another illustrative example, the merchant system 115 may track interchange assessments for transactions with the customer and/or other customers over time, e.g., a day, month year, etc., and may determine an average interchange assessment for the customer and/or for the other customers. For instance, the merchant may determine that the average interchange assessment for a transaction in 2019 was approximately $1.75. For a determined interchange assessment of $1.00 for a particular payment method, the merchant system 115 may determine a potential savings of $0.75, and may determine an incentive based on the potential savings, e.g., in order to reduce an average interchange assessment paid by the merchant.

Interaction type preference data from the customer, e.g., payment method preference data from the customer, may be based on a selection entered by the customer and/or incentives provided to the customer by one or more of an instrument issuer, banking institution, etc., for one or more of the payment methods. For example, the customer may have a payment card that includes 2% cash back or another incentive. In another example, the customer may have selected recommendation preferences with regard to a merchant or type of merchant. For example, in some embodiments, the customer may select a preference for minimizing the interchange assessment regardless of benefit to the customer for one or more merchants, e.g., small businesses, charity organizations, etc. In some embodiments, the customer may select a preference for maximizing a value or incentive for the customer. In some embodiments, the customer may pre-select one or more payment methods. In some embodiments, the customer may exclude one or more payment methods from recommendation or selection. Preferences may be applied to a particular merchant, a type of merchant, a group of merchants defined by one or more criteria, e.g., location, category, etc., or may be applied to any or all merchants. Any suitable type of preference may be used.

At step 225, the location-based interaction-type strategy system 130 may determine an interaction strategy for the interaction between the customer and the merchant, e.g., a recommendation of at least one of the plurality of payment methods for use by the customer with the merchant. In some embodiments, the recommendation may be based on one or more of the determined interchange assessments for the payment methods, the merchant data, the payment method preference data, or the like. In some embodiments, the recommendation may include a payment method corresponding to a lowest of the determined interchange assessments.

In some embodiments, the recommendation includes a payment type and/or modality for at least one payment method. As mentioned above, interchange assessments may vary based on a variety of factors. A payment method may incur different assessments based on whether the payment method is processed as an e-payment (e.g., by entering a credit card number online), a payment over a telephone, a payment via a POS system, etc. Thus, the recommendation may include a recommendation for using a particular modality for a particular payment method, e.g., use a credit card via an e-payment vs. the same credit card via a credit swipe. In some embodiments, the location-based interaction-type strategy system 130 may be configured to recommend a payment method that maximizes a value to the customer, e.g., via incentives offered by the merchant for that payment method and/or incentives associated with the payment method itself.

In some embodiments, the merchant system 115 and/or the location-based interaction-type strategy system 130 may be configured to generate and/or adjust incentive data for one or more incentives based on other incentives. In an illustrative example, the merchant system 115 and/or the location-based interaction-type strategy system 130 may determine that an average interchange assessment for the merchant is $1.75, that a first payment method available to the customer may result in an interchange assessment of $1.00, that a second payment method available to the customer may result in an interchange assessment of $1.50, and that a default incentive is based on approximately ⅓ of a savings to the merchant, e.g., $0.25 for the first method and $0.16 for the second method. Additionally, the merchant system 115 and/or the location-based interaction-type strategy system 130 may determine that the customer has a first incentive from an instrument provider for the first payment method that, for this transaction, has a $1.05 value, and a second incentive from a banking institution for the second payment method that, for this transaction has a $1.15 value.

If the customer selects the first payment method, the merchant may save $0.50 ($0.75 in savings minus $0.25 incentive), and the customer will receive a benefit of $1.30 ($0.25 incentive from merchant plus $1.05 provider incentive).

If the customer selects the second payment method, the merchant may save $0.36 ($0.50 in savings minus $0.16 incentive), and the customer may receive a benefit of $1.31 ($0.16 merchant incentive plus $1.15 provider incentive).

The merchant system 115 and/or the location-based interaction-type strategy system 130 may adjust the merchant's incentive for the first payment method from $0.25 to, for example, $0.30, so that if the customer selects the first payment method, the merchant saves $0.45, and the customer will receive a benefit of $1.35, e.g., an increase relative to the second payment method in both savings for the merchant and benefit to the customer.

At step 230, the location-based interaction-type strategy system 130 may transmit the recommendation to the customer device 105. In some embodiments, the recommendation may include a ranked list of one or more of the plurality of payment methods. The ranking may be based on, for example, a benefit to the customer for each payment method, the savings for the merchant for each payment method, and/or predetermined criteria set by the customer, the location-based interaction-type strategy system 130, and/or the third-party system 120.

In some embodiments, the recommendation may also be transmitted to one or more of the merchant system 115 and/or the third-party system 120, e.g., in order to apply one or more incentives determined by the merchant system 115 and/or the location-based interaction-type strategy system 130.

In some embodiments, the strategy, e.g., the recommendation, includes a plurality of payment methods from which the customer may select. In some embodiments, the recommendation may include a single recommendation, e.g., a highest ranked payment method. In some embodiments, the recommendation includes information associated with the benefit to the customer, the savings to the merchant, or the like. For example, the POS system 110, the customer device 105, or another system may be configured to display or output such information to the customer.

In some embodiments, the customer may select a physical payment method based on the recommendation, e.g., by selecting a payment card corresponding to a recommended payment type, and using the selected card when making a purchase from the merchant. In some embodiments, the transmission of the recommendation is configured to cause the customer device 105 to generate a selectable list of payment methods, whereby the customer device 105, in response to selection of a payment method by the user, is configured to activate the selected payment method for use in a transaction, e.g., via an electronic payment, an electronic wallet, or the like. Terms like “electronic payment,” “electronic wallet,” or the like generally encompass a technique of payment whereby a device, e.g., the customer device 105, is used to convey payment method data for a payment method to a POS system in order to execute a transaction using that payment method. In some embodiments, the location-based interaction-type strategy system 130 and/or the customer device 105 is configured to automatically select a payment method based on the recommendation, e.g., a highest ranked payment method and/or a payment method selected according to a criteria preset by the customer or another entity.

At step 235, an interaction item, e.g., a payment method is selected, e.g., by the customer, the customer device 105, and/or the location-based interaction-type strategy system 130. The customer may then present the selected payment method to the merchant when making a transaction, e.g., by providing a selected payment instrument and/or transmitting payment method data to the POS system 110 via the customer device 105 and/or the location-based interaction-type strategy system 130. In some embodiments, such transmission may include a Near-Field-Communication (“NFC”) transmission, a wireless transmission, a visual signal transmission (e.g., a QR code generated by the customer device 105), or the like.

And, at step 240, the merchant may process the interaction and/or transaction, using the presented interaction item and/or payment method, via the POS system 110, and/or other systems from FIG. 1.

In an exemplary use case, a customer may arrive at a merchant's store, whereby the customer device 105 automatically detects such arrival and interacts with the location-based interaction-type strategy system 130 and/or the merchant system 115 to generate a payment method recommendation and automatically select a payment method, e.g., in the manner discussed above. When the customer is ready to make a purchase, the customer may place the customer device 105 near an NFC receiver associated with the POS system 110, whereby the POS system 110 reads payment method data for the automatically selected payment method, and the transaction may then be processed. Thus, the customer may use a recommended payment method without having to make a selection.

In another exemplary use case, a recommendation may include a suggestion to the customer that the customer complete a transaction using an online e-commerce store associated with the merchant, rather than via the POS system 110. For example, the recommendation may suggest ordering a product for in-store pickup or for delivery. In another exemplary use case, the recommendation may include a suggestion for a particular physical payment instrument, or the like.

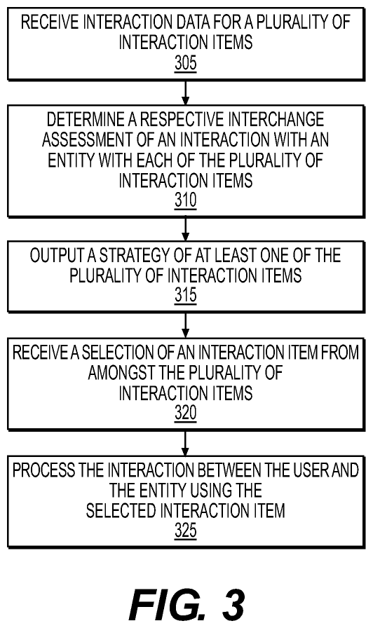

FIG. 3 illustrates another exemplary process for recommending a payment method for a transaction between a customer and a merchant, such as in the various examples discussed above. A customer may arrive at a store associated with a merchant, and may select one or more products for purchase. The customer may present the one or more products to the merchant, and may present one or more payment instruments, e.g., to the POS system 110. In some embodiments, the customer may present a plurality of payment cards. In some embodiments, the customer may present a payment card that includes data configured to provide access to an electronic wallet associated with the customer and including payment data for a plurality of payment methods. In some embodiments, the customer may present a payment card that includes payment data for a plurality of payment methods.

At step 305, the location-based interaction-type strategy system 130 may receive, e.g., via the POS system 110, via access to the electronic wallet, or the like, interaction data for a plurality of interaction items, e.g., payment data for a plurality of payment methods. For example, the location-based interaction-type strategy system 130 may receive payment data for a plurality of payment cards associated with the customer. In an exemplary embodiment, the POS system 110 may include a multi-card reader, e.g., a multi-slot card reader or the like, and the customer may provide a plurality of payment cards at once.

At step 310, the location-based interaction-type strategy system 130 may determine, e.g., based on the received payment data, a respective interchange assessment of an interaction with a merchant with each of the plurality of payment methods. In some embodiments, such determination may include steps or operations similar to the determination of interchange assessments discussed above, e.g., with regard to FIG. 2. In some embodiments, the location-based interaction-type strategy system 130 may receive and/or obtain a transaction price for the products presented to the merchant by the customer, and thus may determine interchange assessments based on the actual transaction price instead of and/or in addition to the default or predicted price.

At step 315, the location-based interaction-type strategy system 130 may output, e.g., via a display of the POS system 110 and/or another system, a strategy e.g., a recommendation, of at least one of the plurality of payment methods, e.g., one of the provided payment cards, based on the respective interchange assessments. The recommendation may be determined, for example, in a manner similar to the manner discussed above, and may include information such as incentive(s) interchange assessment(s) or the like.

At step 320, the location-based interaction-type strategy system 130, POS system 110, and/or another system may receive a selection of an interaction item from amongst the plurality of interaction items, e.g., a payment method from amongst the plurality of payment methods available to and/or provided by the customer. In some embodiments, the selection may be received from the customer, e.g., via an input device of the POS system 110 or the like. In some embodiments, the selection may be received from the merchant, the merchant system 115, the POS system 110, the location-based interaction-type strategy system 130, or another system.

At step 325, the POS system 110, the merchant system 115, the location-based interaction-type strategy system 130, and/or another system may process the interaction between the customer and the merchant using the selected interaction item.

Although the processes discussed above with regard to FIGS. 2 and 3 pertain to a customer visiting a physical store associated with a merchant, it should be understood that one or more aspects of the methods or features discussed above may be incorporated or adapted to a method involving a transaction between a customer and a merchant that does not take place at a physical store. For example, the customer may access an e-commerce store associated with the merchant via the customer device 105. The customer device 105 may have access to payment data associated with payment methods available to the customer. The customer device 105 may include a sensor capable of receiving payment data from a payment instrument, e.g., a chip reader, image capturing device, wireless antenna, or the like, and thus in some embodiments, at least a portion of the POS system 110 may be incorporated into the customer device 105.

Further aspects of the disclosure are discussed in the additional embodiments below. It should be understood that embodiments in this disclosure are exemplary only, and that other embodiments may include various combinations of features from other embodiments, as well as additional or fewer features.

In an exemplary embodiment, the location-based interaction-type strategy system 130 may not obtain payment data associated with payment methods available to the customer. For example, the customer may not have or may not have provided access to such information. In some embodiments, the recommendation provided by the location-based interaction-type strategy system 130 to the customer may include a payment method type (e.g., a check, credit card, etc.). For example, in an instance where payment data for a customer is not available, the location-based interaction-type strategy system 130 may recommend a payment method type instead of a particular payment method.

In another exemplary embodiment, the customer device 105 may not have access to the payment data of the customer, but may act as an authentication device that enables the POS system 110 and/or the merchant system 115 to access payment data for the customer, e.g., stored by the location-based interaction-type strategy system 130 and/or another system. For example, upon the customer entering a physical store of the merchant, the customer device 105 may provide authentication information to the POS system 110 and/or the merchant system 115. In response to receiving such authentication information, the POS system 110 and/or the merchant system 115 may interact with the location-based interaction-type strategy system 130 to provide a payment method recommendation to the customer, e.g., via the customer device 105 and/or the POS system 110 or the like. In some embodiments, the POS system 110 may require presentation of at least one payment instrument by the customer, e.g., so that the customer device 105 and the presented payment instrument act as a two-factor authentication of the customer.

In a further exemplary embodiment, a computer-implemented method for recommending a payment method may include: receiving an indication, from a mobile device associated with a customer, that the mobile device has detected that the customer is at a location associated with a merchant; and in response to receiving the indication that the customer is at the location associated with the merchant: obtaining payment method data for a plurality of payment methods associated with the customer; based on the payment method data, determining a respective interchange fee of a transaction with the merchant with each of the plurality of payment methods; and transmitting a recommendation of at least one of the plurality of payment methods to the mobile device based on the respective interchange fees.

In another exemplary embodiment, a payment-type recommendation system may include: a memory storing instructions; a multi-slot card reader configured to read data from a plurality of payment cards; an input device; a display; and at least one processor operatively connected to the memory, the multi-slot card reader, the input device, and the display, and configured to execute the instructions to perform acts. The acts may include: receiving payment data, from the multi-slot card reader, for the plurality of payment cards; and in response to receiving the payment data: based on the payment data, determining a respective interchange fee of a transaction with a merchant with each of the plurality of payment cards; and outputting, on the display, a recommendation of at least one of the plurality of payment cards based on the respective interchange fees.

In an additional exemplary embodiment, a payment-type recommendation system may include: a memory storing instructions; and at least one processor operatively connected to the memory, and configured to execute the instruction to perform acts. The acts may include receiving an indication, from a mobile device associated with a customer, that the mobile device has detected that the customer is at a location associated with a merchant, wherein the detection by the mobile device that the customer is at the location associated with the merchant is based on one or more of: location data of the mobile device matching the location associated with the merchant; or network connection data the mobile device including one or more of a detection to or a connection with a local electronic network associated with the merchant; and in response to receiving the indication that the customer is at the location associated with the merchant: obtaining payment method data for a plurality of payment methods associated with the customer; determining a respective Bank Identification Number (“BIN”) for each of the plurality of payment methods based on the payment method data; based on the respective BINs and the payment method data, determining a respective interchange fee of a transaction with the merchant with each of the plurality of payment methods; and transmitting a recommendation of at least one of the plurality of payment methods to the mobile device based on the respective interchange fees, wherein the recommendation includes a payment method corresponding to a lowest of the respective interchange fees.

In general, any process or operation discussed in this disclosure that is understood to be computer-implementable, such as the process illustrated in FIGS. 2 and 3, may be performed by one or more processors of a computer system, such any of the systems or devices in the computing environment of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

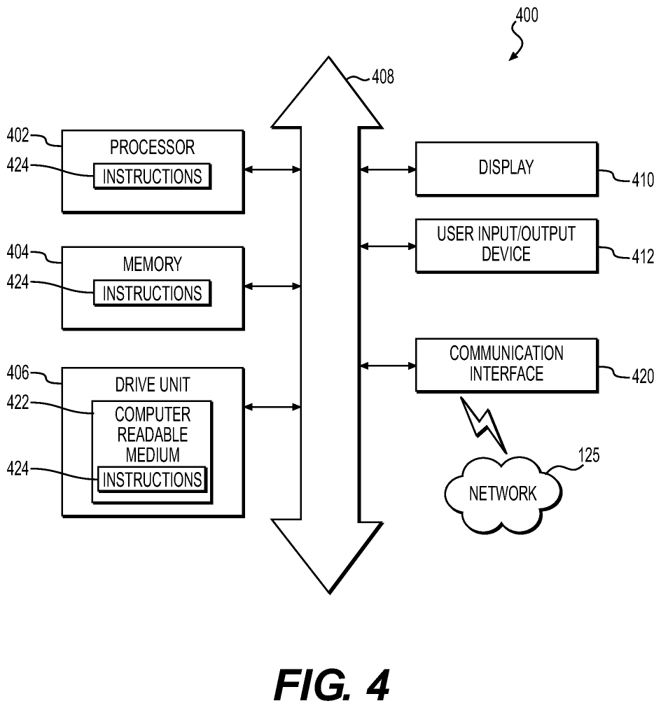

FIG. 4 is a simplified functional block diagram of a computer 400 that may be configured as a device for executing the methods of FIGS. 2 and 3, according to exemplary embodiments of the present disclosure. FIG. 4 is a simplified functional block diagram of a computer that may be configured as the location-based interaction-type strategy system 130 and/or another system according to exemplary embodiments of the present disclosure. In various embodiments, any of the systems herein may be a computer 400 including an assembly of hardware including, for example, a data communication interface 420 for packet data communication. The hardware also may include a central processing unit (“CPU”) 402, in the form of one or more processors, for executing program instructions. The hardware may include an internal communication bus 408, and a storage unit 406 (such as ROM, HDD, SDD, etc.) that may store data on a computer readable medium 422, although the hardware may receive programming and data via network communications. The hardware may also have a memory 404 (such as RAM) storing instructions 424 for executing techniques presented herein, although the instructions 424 may be stored temporarily or permanently within other modules of computer 400 (e.g., processor 402 and/or computer readable medium 422). The hardware also may include input and output ports 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, an automobile entertainment system, a home entertainment system, etc. Also, the presently disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for providing a location-based interaction-type strategy, comprising:
receiving an indication, from a mobile device associated with a user, that the mobile device has detected that the user is at a location associated with an entity; and
in response to receiving the indication that the user is at the location associated with the entity:
obtaining interaction data for a plurality of interaction types associated with the user;
based on the interaction data, determining a respective interchange assessment of an interaction with the entity with each of the plurality of interaction types; and
transmitting a strategy of at least one of the plurality of interaction types to the mobile device based on the respective interchange assessment.

2. The computer-implemented method of claim 1, further comprising:
retrieving, from an entity system associated with the entity, entity interaction data, wherein the determining of the respective interchange assessment is further based on the entity interaction data.

3. The computer-implemented method of claim 1, wherein the strategy includes an interaction type corresponding to a lowest of the respective interchange assessments.

4. The computer-implemented method of claim 1, wherein the strategy includes a modality for the at least one of the plurality of interaction types.

5. The computer-implemented method of claim 1, further comprising:
retrieving interaction type preference data from an entity system associated with the entity, wherein:
the interaction type preference data includes one or more of:
incentive data associated with the respective interchange assessment of at least one of the plurality of interaction types; or
an identification of a preferred interaction type; and
the strategy is based on the interaction type preference data.

6. The computer-implemented method of claim 5, further comprising:
receiving historical interaction type data from an entity system associated with the entity, the historical interaction type data including interchange assessment data for a plurality of historical interactions between the entity and different users using different interaction types; and
determining, based on the historical interaction type data, an incentive for at least one interaction type configured to reduce an average interchange assessment for interactions with the entity, wherein the incentive data includes the incentive.

7. The computer-implemented method of claim 1, wherein the detection by the mobile device that the user is at the location associated with the entity is based on one or more of:
location data of the mobile device matching the location associated with the entity; or
network connection data the mobile device including one or more of a detection to or a connection with a local electronic network associated with the entity.

8. The computer-implemented method of claim 7, wherein the location data is indicative that the user has been at the location associated with the entity for at least a predetermined period of time.

9. The computer-implemented method of claim 1, wherein the strategy is based on a previously received preference of the user.

10. The computer-implemented method of claim 1, wherein the interaction type data is obtained from a digital wallet associated with the user.

11. The computer-implemented method of claim 10, further comprising:
receiving a selection from the user, via the mobile device, of an interaction type from amongst the plurality of interaction types; and
processing an interaction between the user and the entity using the selected interaction type.

12. The computer-implemented method of claim 10, further comprising:
automatically selecting one of the plurality of interaction types based on the strategy; and
processing an interaction between the user and the entity using the selected interaction type.

13. A location-based interaction type strategy system, comprising:
a memory storing instructions;
a multi-slot item reader configured to read data from a plurality of interaction items;
an input device;
a display; and
at least one processor operatively connected to the memory, the multi-slot item reader, the input device, and the display, and configured to execute the instructions to perform acts, including:
receiving interaction data, from the multi-slot item reader, for the plurality of interaction items; and
in response to receiving the interaction data:
based on the interaction data, determining a respective interchange assessment of a interaction with an entity with each of the plurality of interaction items; and
outputting, on the display, a strategy of at least one of the plurality of interaction items based on the respective interchange assessment.

14. The location-based interaction type strategy system of claim 13, wherein:
the memory includes interaction type preference data;
the interaction type preference data includes one or more of:
incentive data associated with the respective interchange assessment of at least one of the plurality of interaction items; or
an identification of a preferred interaction item; and
the strategy is based on the interaction type preference data.

15. The location-based interaction type strategy system of claim 14, wherein:
the acts further include:
obtaining historical interaction type data, the historical interaction type data including interchange assessment data for a plurality of historical interactions between the entity and different users using different interaction items; and
determining, based on the historical interaction type data, an incentive for at least one interaction item configured to reduce an average interchange assessment for interactions with the entity; and
the incentive data includes the incentive.

16. The location-based interaction type strategy system of claim 13, wherein the strategy includes an interaction item corresponding to a lowest of the respective interchange assessments.

17. The location-based interaction type strategy system of claim 13, wherein the location-based interaction type strategy system includes a point-of-sale system.

18. The location-based interaction type strategy system of claim 17, wherein the acts further include:
receiving a selection from a user, via the input device, of an interaction item from amongst the plurality of interaction items; and
processing an interaction between the user and the entity using the selected interaction item.

19. The location-based interaction type strategy system of claim 17, wherein the acts further include:
automatically selecting one of the plurality of interaction items based on the strategy; and
processing an interaction between a user and the entity using the selected interaction item.

20. A location-based interaction type strategy system comprising:
a memory storing instructions; and
at least one processor operatively connected to the memory, and configured to execute the instructions to perform acts, including:
receiving an indication, from a mobile device associated with a user, that the mobile device has detected that the user is at a location associated with an entity, wherein the detection by the mobile device that the user is at the location associated with the entity is based on one or more of:
location data of the mobile device matching the location associated with the entity; or
network connection data the mobile device including one or more of a detection to or a connection with a local electronic network associated with the entity; and
in response to receiving the indication that the user is at the location associated with the entity:
obtaining interaction type data for a plurality of interaction types associated with the user;
determining a respective Bank Identification Number (“BIN”) for each of the plurality of interaction types based on the interaction type data;
based on the respective BIN and the interaction type data, determining a respective interchange assessment of a interaction with the entity with each of the plurality of interaction types; and
transmitting a strategy of at least one of the plurality of interaction types to the mobile device based on the respective interchange assessment, wherein the strategy includes an interaction type corresponding to a lowest of the respective interchange assessment.
